(19) United States
(12) Patent Application Publication
(10) Pub. No.: US 2015/0030070 A1
(43) Pub. Date: Jan. 29, 2015

(54) ADAPTIVE DECODING OF A VIDEO FRAME IN ACCORDANCE WITH INITIATION OF NON-SEQUENTIAL PLAYBACK OF VIDEO DATA ASSOCIATED THEREWITH

(71) Applicant: NVIDIA Corporation, Santa Clara, CA (US)

(72) Inventors: Shivram Latpate, Pune (IN); Masood Shaikh, Pune (IN)

(73) Assignee: NVIDIA Corporation, Santa Clara, CA (US)

(21) Appl. No.: 13/952,686

(22) Filed: Jul. 29, 2013

(51) Int. Cl. H04N 19/44; H04N 19/577; H04N 19/65

(52) U.S. Cl. CPC H04N 19/00533; H04N 19/00854; H04N 19/00721
USPC 375/240.15

(57) ABSTRACT

A method includes determining that a reference video frame of a predicted frame or a bi-predicted frame, corresponding to a point in time of beginning of a non-sequential playback of video data and currently being decoded, is unavailable or corrupt. The method also includes determining if a reference video frame utilized most recently with reference to the point in time to decode another video frame is available in the memory. Further, the method includes decoding the predicted frame or the bi-predicted frame based on employing the reference video frame utilized most recently as a reference video frame thereof if the reference video frame utilized most recently is determined to be available; if not, the decoding is based on employing a video frame of the video data in the memory temporally closest to the point in time as the reference video frame of the predicted frame or the bi-predicted frame.

### FIELD OF TECHNOLOGY

This disclosure relates generally to video decoding and, more particularly, to a method, a device and/or a system of adaptive decoding of a video frame in accordance with initiation of non-sequential playback of video data associated therewith.

### BACKGROUND

Decoding of a predicted video frame (e.g., a P-frame) or a bi-predicted video frame (e.g., a B-frame) may require one or more reference frames thereof. In case of the one or more reference frames being unavailable (e.g., following a seek event on a user interface of a multimedia application rendering video data thereon; the seek event initiates a non-sequential playback of the video data) to a processor of a data processing device or a hardware block performing the decoding, the processor or the hardware block may ignore the one or more reference frames or skip the decoding of the predicted video frame or the bi-predicted video frame. A scheme incorporating such a decoding technique may, therefore, lead to corruption in the decoded video data.

### SUMMARY

Disclosed are a method, a device and/or a system of adaptive decoding of a video frame in accordance with initiation of non-sequential playback of video data associated therewith.

In one aspect, a method includes determining, through a decoder engine executing on a processor communicatively coupled to a memory and/or a hardware decoder, that a reference video frame of a predicted frame or a bi-predicted frame, corresponding to a point in time of beginning of a non-sequential playback of video data including an encoded form of the predicted frame or the bi-predicted frame and currently being decoded, is unavailable or corrupt. Also, the method includes determining, through the decoder engine and/or the hardware decoder, if a reference video frame utilized most recently with reference to the point in time to decode another video frame of the video data is available in the memory following the determination of the unavailability or the corruptness of the reference video frame of the predicted frame or the bi-predicted frame.

Further, the method includes decoding, through the decoder engine and/or the hardware decoder, the predicted frame or the bi-predicted frame based on employing the reference video frame utilized most recently as a reference video frame of the predicted frame or the bi-predicted frame if the reference video frame utilized most recently is determined to be available in the memory. Still further, the method includes decoding, through the decoder engine and/or the hardware decoder, the predicted frame or the bi-predicted frame based on employing a video frame of the video data in the memory temporally closest to the point in time as the reference video frame of the predicted frame or the bi-predicted frame if the reference video frame utilized most recently is determined to be unavailable in the memory.

In another aspect, a data processing device includes a memory, and a processor communicatively coupled to the memory. The processor is configured to execute instructions to determine that a reference video frame of a predicted frame or a bi-predicted frame, corresponding to a point in time of beginning of a non-sequential playback of video data including an encoded form of the predicted frame or the bi-predicted frame and currently being decoded, is unavailable or corrupt. The processor is also configured to execute instructions to determine if a reference video frame utilized most recently with reference to the point in time to decode another video frame of the video data is available in the memory following the determination of the unavailability or the corruptness of the reference video frame of the predicted frame or the bi-predicted frame.

Further, the processor is configured to execute instructions to decode the predicted frame or the bi-predicted frame based on employing the reference video frame utilized most recently as a reference video frame of the predicted frame or the bi-predicted frame if the reference video frame utilized most recently is determined to be available in the memory. Still further, the processor is configured to execute instructions to decode the predicted frame or the bi-predicted frame based on employing a video frame of the video data in the memory temporally closest to the point in time as the reference video frame of the predicted frame or the bi-predicted frame if the reference video frame utilized most recently is determined to be unavailable in the memory.

In yet another aspect, a system includes a source data processing device configured to encode video data including data associated with a predicted frame or a bi-predicted frame as a video sequence. The predicted frame or the bi-predicted frame corresponds to a point in time of beginning of a non-sequential playback of the video data. The system also includes a decoder communicatively coupled to the source data processing device. The decoder is a hardware decoder and/or a decoder engine executing on a processor communicatively coupled to a memory.

The decoder is configured to determine that a reference video frame of the predicted frame or the bi-predicted frame, when currently being decoded, is unavailable or corrupt, and to determine if a reference video frame utilized most recently with reference to the point in time to decode another video frame of the video data is available in the memory following the determination of the unavailability or the corruptness of the reference video frame of the predicted frame or the bi-predicted frame.

Also, the decoder is configured to decode the predicted frame or the bi-predicted frame based on employing the reference video frame utilized most recently as a reference video frame of the predicted frame or the bi-predicted frame if the reference video frame utilized most recently is determined to be available in the memory. Further, the decoder is configured to decode the predicted frame or the bi-predicted frame based on employing a video frame of the video data in the memory temporally closest to the point in time as the reference video frame of the predicted frame or the bi-predicted frame if the reference video frame utilized most recently is determined to be unavailable in the memory.

The methods and systems disclosed herein may be implemented in any means for achieving various aspects, and may be executed in a form of a non-transitory machine-readable medium embodying a set of instructions that, when executed by a machine, cause the machine to perform any of the operations disclosed herein.

Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a video system, according to one or more embodiments.

FIG. 2 is a schematic view of a multimedia framework implemented in a client device of the video system of FIG. 1, according to one or more embodiments.

FIG. 3 is a schematic view of a user interface of a multimedia application executing on the client device of the video system of FIG. 1, according to one or more embodiments.

FIG. 4 is a schematic view of a video frame, according to one or more embodiments.

FIG. 5 is an illustrative view of decoding a predicted frame having no reference video frame thereof, according to one or more embodiments.

FIG. 6 is a flowchart detailing the operations involved in the decoding of the predicted frame having no reference video frame thereof, according to one or more embodiments.

FIG. 7 is a process flow diagram detailing the operations involved in adaptive decoding of a video frame in accordance with initiation of non-sequential playback of video data associated therewith, according to one or more embodiments.

Other features of the present embodiments will be apparent from the accompanying drawings and from the detailed description that follows.

### DETAILED DESCRIPTION

Example embodiments, as described below, may be used to provide a method, a device and/or a system of adaptive decoding of a video frame in accordance with initiation of non-sequential playback of video data associated therewith. Although the present embodiments have been described with reference to specific example embodiments, it will be evident that various modifications and changes may be made to these embodiments without departing from the broader spirit and scope of the various embodiments.

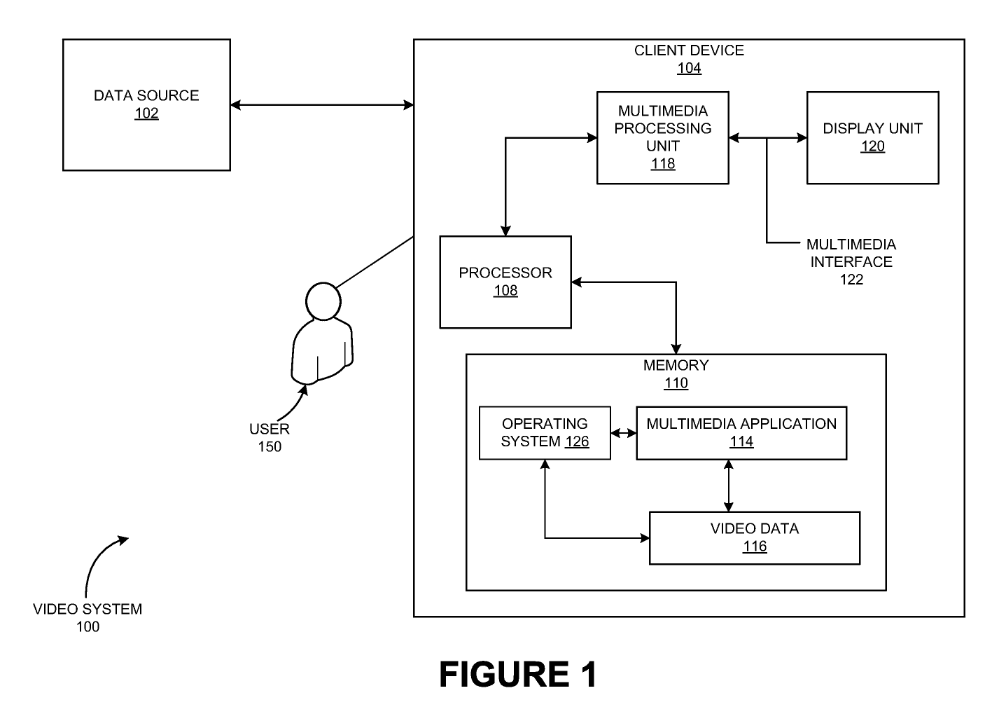

FIG. 1 shows a video system 100, according to one or more embodiments. In one or more embodiments, video system 100 may include a data source 102 communicatively coupled to a client device 104 (e.g., through a computer network such as Internet, a Local Area Network (LAN) and a Wide Area Network (WAN), or, through a direct coupling). It should be noted that data source 102 and client device 104 may be the same data processing device (e.g., a desktop computer, a laptop computer, a notebook computer, a netbook or a mobile device such as a mobile phone). In one or more embodiments, data source 102 may be a server configured to encode a video sequence as video data and transmit the video data to client device 104.

In one or more embodiments, client device 104 may include a processor 108 communicatively coupled to a memory 110. In one or more embodiments, processor 108 may be a Central Processing Unit (CPU), a Graphics Processing Unit (GPU) and/or any dedicated processor configured to execute an appropriate decoding engine thereon (decoding engine may instead be hardware); the dedicated processor may, alternately, be configured to control the appropriate decoding engine executing on another processor. All variations therein are within the scope of the exemplary embodiments. In one or more embodiments, memory 110 may be a volatile memory and/or a non-volatile memory.

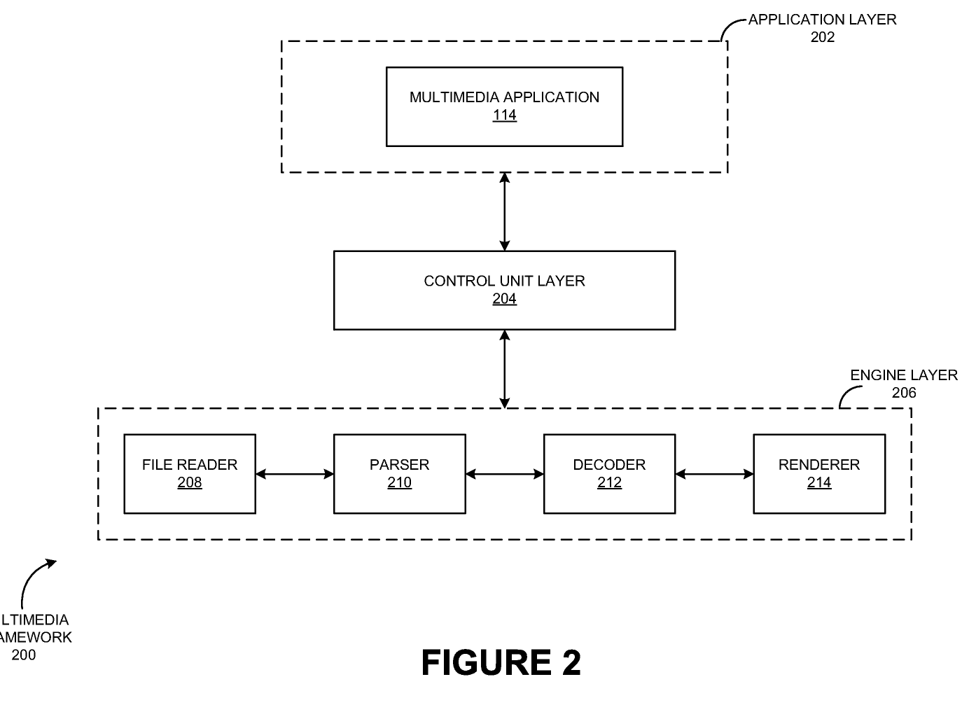

In one or more embodiments, client device 104 may execute a multimedia application 114 on processor 108; multimedia application 114 may be configured to render video data as a stream on an interface thereon. FIG. 1 shows multimedia application 114 as being stored in memory 110 to be executed on processor 108. FIG. 1 also shows video data 116 to be rendered through multimedia application 114 as being resident in memory 110 (e.g., volatile memory). In one or more embodiments, multimedia application 114 may utilize an Application Programming Interface (API) of a multimedia framework (to be discussed with regard to FIG. 2) in order to perform processing associated therewith.

In one or more embodiments, output data associated with processing through processor 108 may be input to a multimedia processing unit 118 configured to perform encoding/decoding associated with the data. In one or more embodiments, the output of multimedia processing unit 118 may be rendered on a display unit 120 (e.g., Liquid Crystal Display (LCD) display, Cathode Ray Tube (CRT) monitor) through a multimedia interface 122 configured to convert data to an appropriate format required by display unit 120.

FIG. 2 shows a multimedia framework 200 implemented in client device 104, according to one or more embodiments. In one or more embodiments, multimedia framework 200 may provide multimedia capture, processing and playback facilities utilizing local or remote sources. In one or more embodiments, multimedia framework 200 may be above a foundation layer that facilities access of hardware such as a soundcard/display unit 120. In one or more embodiments, multimedia framework 200 may include an application layer 202 configured to communicate with a control unit layer 204 to enable performing a task required by multimedia application 114. Thus, multimedia application 114 may be at a level of application layer 202. In one or more embodiments, control unit layer 204 may control dataflow through engines (or, modules; shown as part of engine layer 206) of multimedia framework 200 such as file reader 208, parser 210, decoder 212 (e.g., hardware engine or software engine) and renderer 214.

File reader 208 may be configured to enable reading of video data 116. Parser 210 (e.g., Moving Picture Experts Group (MPEG) parser, Audio-Video Interleave (AVI) parser, H.264 parser) may parse video data 116 into constituent parts thereof. Decoder 212 may decode a compressed or an encoded version of video data 116 and renderer 214 may transmit the decoded data to a destination (e.g., a rendering device). The rendering process may also include processes such as displaying multimedia on display unit 120, playing an audio file on a soundcard, writing the data to a file etc.

It is obvious that the abovementioned engines (or, modules) are merely shown for illustrative purposes and that variations therein are within the scope of the exemplary embodiments. Further, it is obvious that multimedia framework 200 is merely shown for illustrative purposes, and that exemplary embodiments are not limited to implementations involving multimedia framework 200.

In typical solutions, a video frame of video data 116 may be received at client device 104, following which a decoder thereat decodes the video frame. Any video frame successfully decoded may become one of the reference frames to be utilized in decoding succeeding video frames of video data 116. Typically, video frames of video data 116 may be encoded with key frames (e.g., intra-frames; key frames may bookend a distinct transition in a scene of video data 116) at regular intervals. When a user 150 of client device 104 initiates a non-sequential playback of video data 116 on multimedia application 114 through a user interface thereof by seeking to a desired point in time of video data 116, the key frame closest to the desired point in time may be utilized to decode succeeding video frames.

In certain video streams associated with video telephony and/or Voice over Internet Protocol (VoIP) based applications, video data 116 may include a key frame at a start of the video sequence. All subsequent video frames may be predicted frames (P-frames). The aforementioned encoding may be employed to maintain a constant bit rate of communication over the communication channel associated with video telephony. In the case of sequential playback of such an encoded video stream, the first key frame may be decoded (e.g., through decoder 212) without an external reference video frame. The remaining predicted frames may have previously decoded video frames as reference frames thereof.

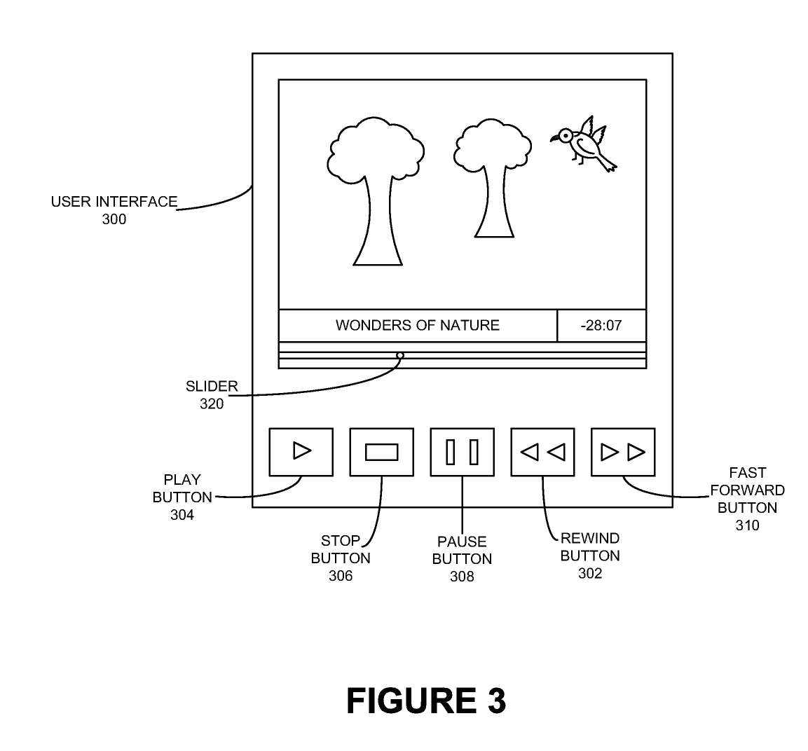

Also, portions (e.g., macroblocks) of video data 116 may not require reference video frames. The aforementioned portions may be smartly encoded as “intra.” In one or more embodiments, multimedia application 114 (e.g., a video player) may have features associated with non-sequential playback such as Fast Forward and Rewind. FIG. 3 shows a user interface 300 of multimedia application 114, according to one or more embodiments. In one or more embodiments, user interface 300 may include a rewind button 302, a play button 304, a stop button 306, a pause button 308 and a fast-forward button 310. The aforementioned buttons are self-explanatory; initiation of non-sequential playback through rewind button 302 and fast-forward button 310 and/or utilization of play button 304, stop button 306 and pause button 308 may require a driver component (e.g., driver component associated with processor 108 and/or display unit 120, driver component packaged with an operating system 126 (e.g., shown as being stored in memory 110 of FIG. 1) executing on client device 104, driver component packaged with multimedia application 114 and/or associated software) therefor. In one or more embodiments, multimedia application 114 may transmit events related to the action performed by user 150 on user interface 300 to multimedia framework 200. For example, if user 150 moves a slider (e.g., slider 320) associated with non-sequential playback on user interface 300 of multimedia application 114 after loading video data 116 (e.g., a video file) thereon, an event associated therewith may be transmitted to multimedia frame work 200. Multimedia framework 200 may then perform requisite processing associated with the action of user 150 through processor 108.

When non-sequential playback of video data 116 is initiated by user 150, decoder 212 may receive an encoded key frame from memory 110 to decode a current video frame from a new point in time associated with the action corresponding to the non-sequential playback (e.g., a seek action). The encoded key frames may be stored in memory 110 to be utilized to decode other video frames. In typical implementations, playback may start from a key frame temporally closest to the new point in time because the key frame may be independently decoded, and the video frames following the key frame may be decoded based on the key frame.

As mentioned above, when video data 116 is encoded in a video telephony scenario, video data 116 may include only one key frame (e.g., an intra-frame); the other video frames thereof may be predicted frames. Here, no key frame may exist near the new point in time associated with the seek action. When decoder 212 receives a predicted frame at the new point in time to be decoded, decoder 212 may raise an error alarm and, subsequently, defer decoding of the current predicted frame. Therefore, non-sequential playback may either fail or continue with corruption visible to user 150 through multimedia application 114. Exemplary embodiments discussed herein provide for reduced corruption during non-sequential playback.

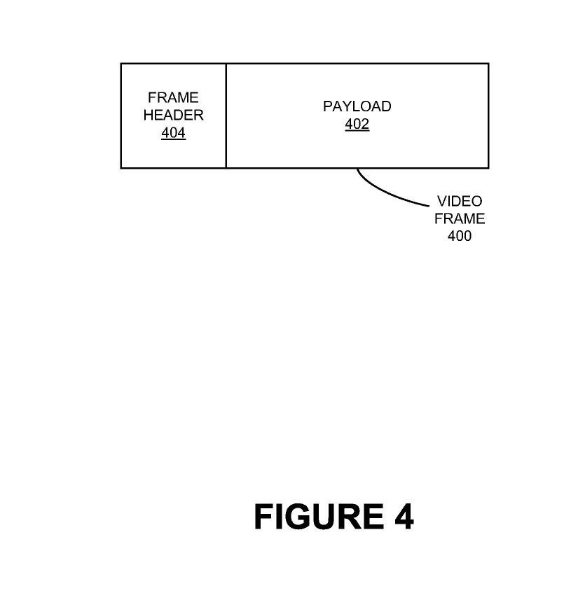

In one or more embodiments, in accordance with the initiation of non-sequential playback (e.g., a jump to any temporal point in time in accordance with a change in position of slider 320), parser 210 may read a current video frame to be decoded from the new point in time. In one or more embodiments, decoder 212 may then check the frame header (e.g., frame header 404 in FIG. 4, which shows an exemplary video frame 400 further including a payload 402 thereof) to determine a type of the current video frame. In one or more embodiments, if the current video frame is a key frame, decoder 212 may decode said key frame without a reference video frame therefor. In one or more embodiments, if the current video frame is a predicted frame, decoder 212 may preserve a reference video frame (e.g., a key frame, an intra-frame, a predicted frame or a bi-predicted frame) in memory 110 (e.g., volatile memory) most recently utilized for predicting/decoding a previous video frame prior to the new point in time to be utilized to predict the current video frame. Once the reference video frame is determined and preserved, a buffer of memory 110 associated with video data 116 may be flushed (e.g., through processor 108).

In traditional solutions, decoder 212 may raise an error alarm and stop decoding the current video frame if the current video frame corresponding (or, closest) to the new point in time is a predicted frame because, theoretically, the predicted frame cannot be decoded without a reference video frame. Exemplary embodiments provide for an adaptive mechanism to predict a video frame even when said video frame does not have a reference video frame therefor.

In one or more embodiments, if the reference video frame utilized for predicting the previous video frame is unavailable in memory 110, decoder 212 may preserve a previously decoded video frame (e.g., a key frame, an intra-frame, a predicted frame or a bi-predicted frame) in memory 110 temporally closest to the point in time associated with the seek action. In one or more embodiments, the preserved video frame may be utilized to predict the current video frame (predicted frame). Again, in one or more embodiments, data other than the preserved video frame may be flushed from the buffer of memory 110. In one or more embodiments, if all macroblocks (or, to generalize, constituent portions) of the current video frame (e.g., predicted frame) are “intra,” then the current video frame may not require a reference video frame; decoder 212 may determine the lack of a requirement of a reference video frame and decode the current video frame accordingly.

In one or more embodiments, utilization of the most recent reference video frame/non-reference decoded video frame in memory 110 when an actual reference video frame of the current video frame is unavailable may ensure increased decoding quality compared to existing implementations (e.g., involving error concealment) because video frames temporally close to one another merely have gradual variation in constituent portions (e.g., macroblocks) thereof.

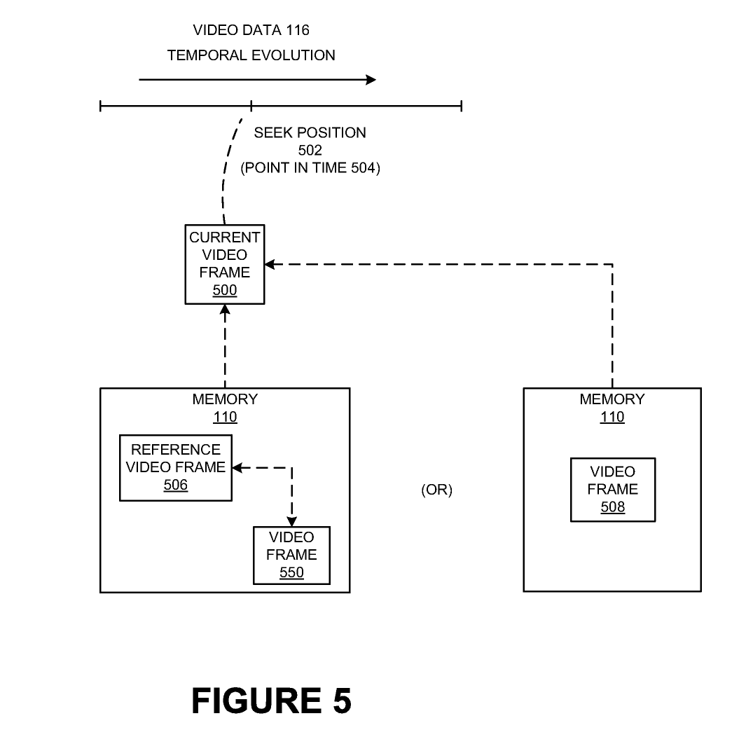

In one or more embodiments, in the best case scenario, the output of the decoding may be exact if the preserved reference video frame is the actual reference video frame of the current video frame. FIG. 5 illustrates the abovementioned technique of predicting a current video frame 500 that is a predicted frame having no reference video frame thereof, according to one or more embodiments. In one or more embodiments, current video frame 500 may relate to a seek position 502 discussed above that corresponds to a point in time 504. In one or more embodiments, as discussed above, a reference video frame 506 in memory 110 (including video data 550) most recently utilized for predicting/decoding a video frame 550 prior to point in time 504 may be preserved therein to be utilized to predict/decode current video frame 500. In one or more embodiments, when even reference video frame 506 is unavailable, a video frame 508 in memory 110 temporally closest to point in time 504 may be utilized to predict current video frame 500.

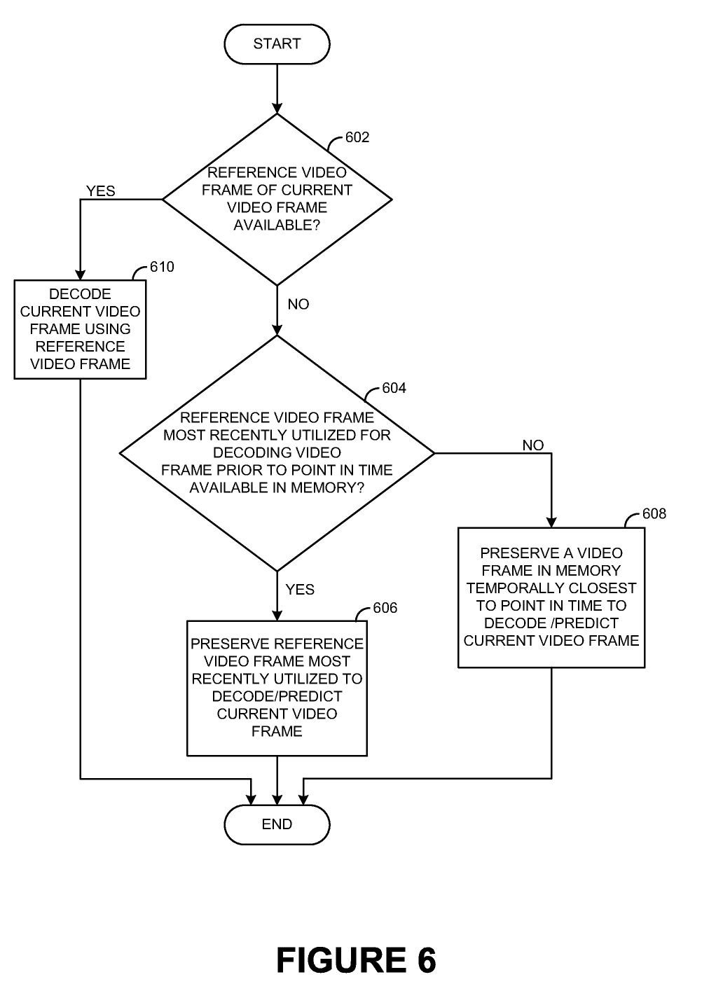

FIG. 6 summarizes the operations discussed above in a flowchart, according to one or more embodiments. In one or more embodiments, operation 602 may involve checking as to whether a reference video frame of current video frame 500 is available in memory 110 to decoder 212. If yes, current video frame 500 may be decoded using the reference video frame thereof in operation 610. In one or more embodiments, if no, operation 604 may involve checking as to whether reference video frame 506 most recently utilized for predicting/decoding video frame 550 prior to point in time 504 is available in memory 110. In one or more embodiments, if yes, operation 606 may involve preserving reference video frame 506 in memory 110 to utilize said reference video frame 506 to predict current video frame 500. In one or more embodiments, if no, operation 608 may involve utilizing video frame 508 in memory 110 to predict current video frame 500.

It should be noted that the concepts discussed above also apply to decoding bi-predicted video frames of video data 116. A bi-predicted video frame (B-frame) may require one or more reference video frames in the temporal past and one or more reference video frames in the temporal future for prediction thereof. Also, it should be noted that more than one reference video frames (e.g., one or more of reference video frame 506, one or more of video frame 508 or a combination thereof) in a temporal past compared to point in time 504 may be utilized for prediction of current video frame 500.

In the case of current video frame 500 being a bi-predicted frame, it should be noted that the same reference video frame 506 or video frame 508 may be utilized as a reference video frame of current video frame 500 in a temporal future compared to point in time 504 when an actual reference video frame of current video frame 500 in the temporal future is unavailable, according to one or more embodiments. In one or more alternate embodiments, a reference video frame (e.g., a key frame, an intra-frame, a predicted frame or a bi-predicted frame) of another video frame closest to point in time 504 in a temporal future may be utilized as the reference video frame in the temporal future of current video frame 500. Further, in one or more embodiments, if the reference video frame of the another video frame is also unavailable in memory 110, a video frame (e.g., a key frame, an intra-frame, a predicted frame or bi-predicted frame) in a temporal future closest to point in time 504 may be preserved in memory 110 to predict/decode current video frame 500. Typically, reference video frames in the temporal future may be encoded before current video frame 500 during the encoding process; the aforementioned reference video frames may be made available in memory 110.

Also, it should be noted that the concepts discussed herein are not solely application to scenarios where the reference video frame(s) of a current video frame being decoded is unavailable in memory 110. The concepts may also be applicable when the reference video frame(s) are deemed (e.g., through processor 108) to be corrupt. In a software implementation, the operations/processes discussed above may be performed through processor 108. Further, instructions associated with the operations/processes and/or the driver component discussed above may be tangibly embodied on a non-transitory medium (e.g., a Compact Disc (CD), a Digital Video Disc (DVD), a Blu-Ray Disc®, a hard drive; appropriate instructions may be downloaded to the hard drive) readable through client device 104. All reasonable variations are within the scope of the exemplary embodiments discussed herein.

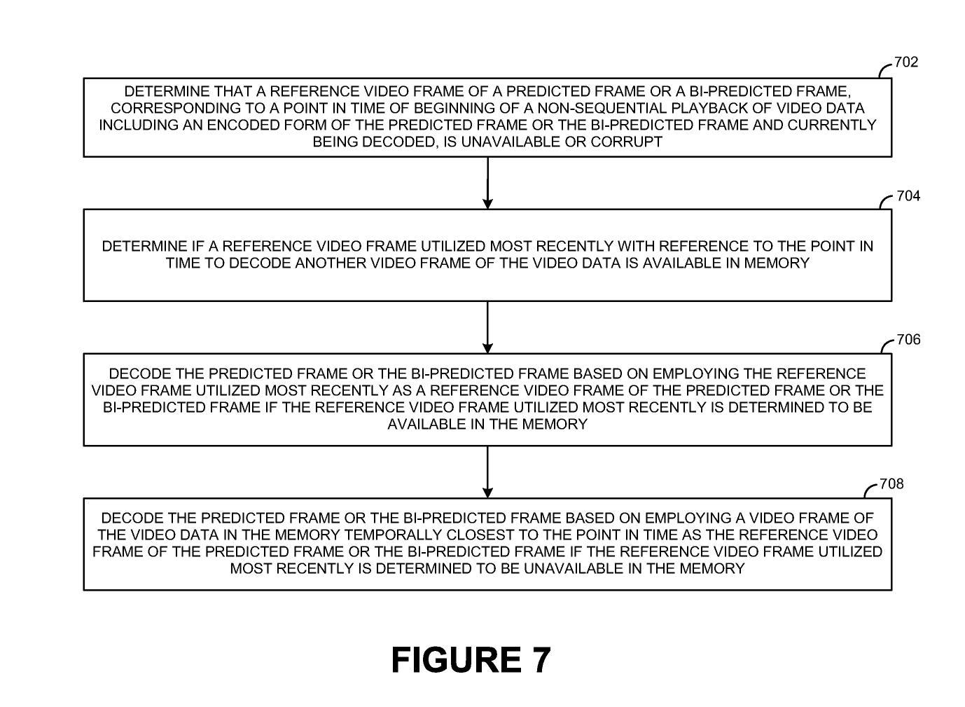

FIG. 7 shows a process flow diagram detailing the operations involved in adaptive decoding of a predicted video frame or a bi-predicted video frame in accordance with initiation of non-sequential playback of video data 116 associated therewith, according to one or more embodiments. In one or more embodiments, operation 702 may involve determining, through a decoder engine executing on processor 108 communicatively coupled to memory 110 and/or a hardware decoder, that a reference video frame of the predicted frame or the bi-predicted frame, corresponding to a point in time of beginning of the non-sequential playback of video data 116 including an encoded form of the predicted frame or the bi-predicted frame and currently being decoded, is unavailable or corrupt.

In one or more embodiments, operation 704 may involve determining, through the decoder engine and/or the hardware decoder, if a reference video frame utilized most recently with reference to the point in time to decode another video frame of video data 116 is available in memory 110 following the determination of the unavailability or the corruptness of the reference video frame of the predicted frame or the bi-predicted frame. In one or more embodiments, operation 706 may involve decoding, through the decoder engine and/or the hardware decoder, the predicted frame or the bi-predicted frame based on employing the reference video frame utilized most recently as a reference video frame of the predicted frame or the bi-predicted frame if the reference video frame utilized most recently is determined to be available in memory 110.

In one or more embodiments, operation 708 may then involve decoding, through the decoder engine and/or the hardware decoder, the predicted frame or the bi-predicted frame based on employing a video frame of video data 116 in memory 110 temporally closest to the point in time as the reference video frame of the predicted frame or the bi-predicted frame if the reference video frame utilized most recently is determined to be unavailable in memory 110.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a non-transitory machine-readable medium). For example, the various electrical structures and methods may be embodied using transistors, logic gates, and electrical circuits (e.g., application specific integrated (ASIC) circuitry and/or Digital Signal Processor (DSP) circuitry).

In addition, it will be appreciated that the various operations, processes and methods disclosed herein may be embodied in a non-transitory machine-readable medium and/or a machine-accessible medium compatible with a data processing system (e.g., client device 104). Accordingly, the specification and drawings are to be regarded in an illustrative rather than a restrictive sense.

What is claimed is:

1. A method comprising:
determining, through at least one of a decoder engine executing on a processor communicatively coupled to a memory and a hardware decoder, that a reference video frame of one of: a predicted frame and a bi-predicted frame, corresponding to a point in time of beginning of a non-sequential playback of video data including an encoded form of the one of: the predicted frame and the bi-predicted frame and currently being decoded, is one of: unavailable and corrupt;
determining, through the at least one of the decoder engine and the hardware decoder, if a reference video frame utilized most recently with reference to the point in time to decode another video frame of the video data is available in the memory following the determination of the one of: the unavailability and the corruptness of the reference video frame of the one of: the predicted frame and the bi-predicted frame;
decoding, through the at least one of the decoder engine and the hardware decoder, the one of: the predicted frame and the bi-predicted frame based on employing the reference video frame utilized most recently as a reference video frame of the one of: the predicted frame and the bi-predicted frame if the reference video frame utilized most recently is determined to be available in the memory; and
decoding, through the at least one of the decoder engine and the hardware decoder, the one of: the predicted frame and the bi-predicted frame based on employing a video frame of the video data in the memory temporally closest to the point in time as the reference video frame of the one of: the predicted frame and the bi-predicted frame if the reference video frame utilized most recently is determined to be unavailable in the memory.

2. The method of claim 1, wherein the reference video frame employed to decode the one of: the predicted frame and the bi-predicted frame is one of: an intra-video frame, a key frame, a predicted frame and a bi-predicted frame.

3. The method of claim 1, further comprising determining, through the at least one of the decoder engine and the hardware decoder, a type of a current video frame being decoded as the one of: the predicted frame and the bi-predicted frame based on a frame header thereof.

4. The method of claim 1, further comprising flushing, from a buffer of the memory, video frame data other than the reference video frame employed to decode the one of: the predicted frame and the bi-predicted frame.

5. The method of claim 1, wherein during the decoding of the bi-predicted frame, the method further comprises at least one of:
utilizing the reference video frame employed to decode the bi-predicted frame in both a temporal past and a temporal future compared to the point in time for the decoding of the bi-predicted frame; and
utilizing another reference video frame in the memory in a temporal future compared to the point in time in addition to the reference video frame employed to decode the bi-predicted frame for the decoding of the bi-predicted frame.

6. The method of claim 1, comprising performing the decoding of the one of: the predicted frame and the bi-predicted frame through a multimedia framework executing on the processor including the decoder engine.

7. The method of claim 6, comprising initiating the non-sequential playback through a user interface of a multimedia application executing through the processor, the multimedia application being associated with the multimedia framework.

8. A data processing device comprising:
a memory; and
a processor communicatively coupled to the memory, the processor being configured to execute instructions to:
determine that a reference video frame of one of: a predicted frame and a bi-predicted frame, corresponding to a point in time of beginning of a non-sequential playback of video data including an encoded form of the one of: the predicted frame and the bi-predicted frame and currently being decoded, is one of: unavailable and corrupt,
determine if a reference video frame utilized most recently with reference to the point in time to decode another video frame of the video data is available in the memory following the determination of the one of: the unavailability and the corruptness of the reference video frame of the one of: the predicted frame and the bi-predicted frame,
decode the one of: the predicted frame and the bi-predicted frame based on employing the reference video frame utilized most recently as a reference video frame of the one of: the predicted frame and the bi-predicted frame if the reference video frame utilized most recently is determined to be available in the memory, and
decode the one of: the predicted frame and the bi-predicted frame based on employing a video frame of the video data in the memory temporally closest to the point in time as the reference video frame of the one of:
the predicted frame and the bi-predicted frame if the reference video frame utilized most recently is determined to be unavailable in the memory.

9. The data processing device of claim 8, wherein the reference video frame employed to decode the one of: the predicted frame and the bi-predicted frame is one of: an intra-video frame, a key frame, a predicted frame and a bi-predicted frame.

10. The data processing device of claim 8, wherein the processor is further configured to execute instructions to determine a type of a current video frame being decoded as the one of: the predicted frame and the bi-predicted frame based on a frame header thereof.

11. The data processing device of claim 8, wherein the processor is further configured to execute instructions to flush, from a buffer of the memory, video frame data other than the reference video frame employed to decode the one of: the predicted frame and the bi-predicted frame.

12. The data processing device of claim 8, wherein during the decoding of the bi-predicted frame, the processor is further configured to execute instructions to at least one of:
utilize the reference video frame employed to decode the bi-predicted frame in both a temporal past and a temporal future compared to the point in time for the decoding of the bi-predicted frame, and
utilize another reference video frame in the memory in a temporal future compared to the point in time in addition to the reference video frame employed to decode the bi-predicted frame for the decoding of the bi-predicted frame.

13. The data processing device of claim 8, wherein the processor is configured to execute instructions to perform the decoding of the one of: the predicted frame and the bi-predicted frame through a multimedia framework executing on the data processing device.

14. A system comprising:
a source data processing device configured to encode video data including data associated with one of: a predicted frame and a bi-predicted frame as a video sequence, the one of: the predicted frame and the bi-predicted frame corresponding to a point in time of beginning of a non-sequential playback of the video data; and
a decoder communicatively coupled to the source data processing device, the decoder being at least one of a hardware decoder and a decoder engine executing on a processor communicatively coupled to a memory, and the decoder being configured to:
determine that a reference video frame of the one of: the predicted frame and the bi-predicted frame, when currently being decoded, is one of: unavailable and corrupt,
determine if a reference video frame utilized most recently with reference to the point in time to decode another video frame of the video data is available in the memory following the determination of the one of: the unavailability and the corruptness of the reference video frame of the one of: the predicted frame and the bi-predicted frame,
decode the one of: the predicted frame and the bi-predicted frame based on employing the reference video frame utilized most recently as a reference video frame of the one of: the predicted frame and the bi-predicted frame if the reference video frame utilized most recently is determined to be available in the memory, and
decode the one of: the predicted frame and the bi-predicted frame based on employing a video frame of the video data in the memory temporally closest to the point in time as the reference video frame of the one of:
the predicted frame and the bi-predicted frame if the reference video frame utilized most recently is determined to be unavailable in the memory.

15. The system of claim 14, wherein the reference video frame employed to decode the one of: the predicted frame and the bi-predicted frame is one of: an intra-video frame, a key frame, a predicted frame and a bi-predicted frame.

16. The system of claim 14, wherein the decoder is further configured to determine a type of a current video frame being decoded as the one of: the predicted frame and the bi-predicted frame based on a frame header thereof.

17. The system of claim 14, wherein the decoder is further configured to flush, from a buffer of the memory, video frame data other than the reference video frame employed to decode the one of: the predicted frame and the bi-predicted frame.

18. The system of claim 14, wherein during the decoding of the bi-predicted frame, the decoder is further configured to at least one of:
utilize the reference video frame employed to decode the bi-predicted frame in both a temporal past and a temporal future compared to the point in time for the decoding of the bi-predicted frame, and
utilize another reference video frame in the memory in a temporal future compared to the point in time in addition to the reference video frame employed to decode the bi-predicted frame for the decoding of the bi-predicted frame.

19. The system of claim 14, wherein the decoder is configured to perform the decoding of the one of: the predicted frame and the bi-predicted frame through a multimedia framework executing on the processor.

20. The system of claim 14, wherein the processor executing the decoder engine is one of: part of the source data processing device and external to the source data processing device.
